(19) United States
(12) Patent Application Publication
(10) Pub. No.: US 2026/0210001 A1
(43) Pub. Date: Jul. 23, 2026

(54) METHOD OF RECYCLING COMPOSITE MATERIAL

(71) Applicant: VESTAS WIND SYSTEMS A/S, Aarhus N (DK)

(72) Inventors: Mie REHMEIER, Sabro (DK); Troels Bach NIELSEN, Risskov (DK); Torben Ladegaard BAUN, Skødstrup (DK)

(21) Appl. No.: 19/138,603

(22) PCT Filed: Dec. 13, 2023
(86) PCT No.: PCT/DK2023/050304

§ 371 Date: Jun. 12, 2025

(30) Foreign Application Priority Data
Dec. 13, 2022 (DK) PA202270599

(51) Int. Cl. D01G 11/00; C08J 11/26; F03D 80/00

(52) U.S. Cl. CPC D01G 11/00; C08J 11/26; F03D 80/00; C08J 2363/00; D10B 2101/06

(57) ABSTRACT

A method of recycling composite material, the composite material comprising reinforcement fibres embedded in a matrix material. The method comprises: loading the composite material into a container; treating the composite material in the container with a liquid; transporting the container to a recycling station, wherein the liquid degrades the matrix material in the container during the transporting of the container; and at the recycling station, recycling the reinforcement fibres by separating them from the matrix material. WO

### FIELD OF THE INVENTION

The present invention relates to a method of recycling composite material, such as waste composite material from wind turbine blades or other objects. The invention also relates to a container for transporting composite material.

### BACKGROUND OF THE INVENTION

A review of recycling of waste composite material is presented in Karuppannan Gopalraj, S., Kärki, T. A review on the recycling of waste carbon fibre/glass fibre-reinforced composites: fibre recovery, properties and life-cycle analysis. SN Appl. Sci. 2, 433 (2020). https: //doi.org/10.1007/s42452-020-2195-4.

Recent developments in recycling technologies allows recycling of epoxy-based composite material in a two-step process. The first process step breaks down the epoxy and allows for separation of the various components of the composite material including a fiber fraction. This separation step is performed by soaking the composite material in an acid solution. For large structures like wind turbine blades and without heating this process can take tens of hours and thereby require substantial capacity at the recycling site.

A known method of chemically recycling composite material is disclosed in La Rosa, Angela & Blanco, Ignazio & Banatao, Diosdado & Pastine, Stefan & Björklund, Anna & Cicala, Gianluca. (2018). Innovative Chemical Process for Recycling Thermosets Cured with Recyclamines® by Converting Bio-Epoxy Composites in Reusable Thermoplastic—An LCA Study. Materials. 11. 353. 10.3390/ma11030353.

When waste composite material is transported, it is usually cut into smaller pieces or coarsely shredded prior to transport. Even with these initiatives it is in most cases not possible to utilize the full load capacity of the container on a roadgoing truck (for example 25 tons) due to poor packing of composite waste (low global packing density).

In the best case only approximately 21 tons of material is carried, and in the worst case only half the load carrying capacity of the container is utilized. This increases the transport costs per ton of waste composite material and reduce the (energy) efficiency of recycling.

U.S. Pat. No. 10,953,407 discloses methods for recycling fibre composite source objects, such as wind turbine blades. In some embodiments, the method includes sectioning the wind turbine blades, crushing the wind turbine blade sections, tracking the progress of each blade through the process, and loading output materials into a suitable transportation vessel.

### SUMMARY OF THE INVENTION

A first aspect of the invention provides a method of recycling composite material, the composite material comprising reinforcement fibres embedded in a matrix material, the method comprising: loading the composite material into a container; treating the composite material in the container with a liquid; transporting the container to a recycling station, wherein the liquid degrades the matrix material in the container during the transporting of the container; and at the recycling station, recycling the reinforcement fibres by separating them from the matrix material.

Optionally the liquid is applied to the composite material in the container.

Optionally the liquid is applied to the composite material in the container during the transporting of the container.

Optionally the liquid is sprayed onto the composite material, preferably by spraying the liquid from one or more nozzles within the container.

Optionally the composite material is composite material of a wind turbine blade.

Optionally the container is transported by a vehicle, such as a truck, train or ship, and preferably the composite material is in container and transported with the container.

Optionally the method further comprising storing the container with composite material and liquid after arrival at the recycling station. Optionally the container is stored until a predetermined level of degradation of the composite material is realized.

Optionally the container is closed after loading the composite material into the container, and the container remains closed during the transporting of the container.

Optionally the composite material is removed from the container before the reinforcement fibres are recycled.

Optionally the composite material is loaded into the container as pieces of composite material.

Optionally the method further comprises dividing a part into the pieces of composite material before they are loaded into the container.

Optionally the dividing comprises cutting and/or shredding.

Optionally the part is cut by the liquid.

Optionally the pieces are beads, granules, flakes, chips, shreds, slices or sections.

Optionally at least some of the reinforcement fibres separated from the matrix material have a length greater than 10 cm, or greater than 20 cm.

Optionally the matrix material comprises a thermoset material, which may be cured.

Optionally the matrix material comprises a polymer.

Optionally the matrix material comprises a resin.

Optionally the matrix material comprises an epoxy resin.

Optionally the reinforcement fibres are separated from the matrix material at the recycling station by treating the composite material with a separation agent. Optionally the separation agent is a liquid.

Optionally the liquid and/or the separation agent comprises an acid, preferably with pH below 4, most preferably with a pH below 3. Optionally the acid is acetic acid or formic acid.

Optionally the liquid and/or the separation agent chemically treats the matrix material.

Optionally the liquid and/or the separation agent comprises a solution of an active ingredient in water.

Optionally the liquid and/or the separation agent at least partially chemically disassembles the matrix material, for instance by dissolving or depolymerising the matrix material, or by solvolysis of the matrix material.

Optionally the liquid has the same chemical composition as the separation agent.

Optionally the liquid and/or the separation agent is at a temperature greater than 50° C. or greater than 70° C. as it treats the composite material.

Optionally the liquid is heated so that it is above an ambient temperature outside the container as it treats the composite material in the container.

Optionally the liquid and/or the separation agent is at a temperature less than 100° C. or less than 50° C. as it treats the composite material.

Optionally the liquid and/or the separation agent is at a temperature between 0° C. and 100° C. as it treats the composite material.

Optionally the liquid and/or the separation agent is at a temperature between 20° C. and 50° C. as it treats the pieces.

Optionally the composite material comprises non-composite material, which may or may not be degraded by the liquid.

A further aspect of the invention provides a container for transporting composite material, the container comprising a system configured to apply a liquid onto the composite material, wherein the system comprises a circulation system configured to capture liquid which has contacted the composite material and feed it back onto the composite material.

Optionally the container further comprises a liquid refining station for separating dissolved and/or particulate composite material from the liquid.

Optionally the container further comprises a stock of liquid, preferably in a sump of the container, wherein the system is configured to apply liquid from the stock of liquid onto the composite material.

Optionally the liquid from the stock of liquid comprises an acid. Optionally the acid is acetic acid or formic acid.

Optionally the circulation system comprises one or more nozzles in the container; and a pump configured to feed the liquid to the one or more nozzles.

Optionally the system comprise one or more nozzles configured to spray the liquid onto the composite material.

Optionally the system is configured to apply the liquid onto the composite material from above. Optionally the container has a liquid-tight floor which inhibits leakage of the liquid.

Optionally, the container comprises a pressure release valve.

### BRIEF DESCRIPTION OF THE DRAWINGS

Embodiments of the invention will now be described with reference to the accompanying drawings, in which:

FIG. 1 shows a wind turbine;

FIG. 2 shows a system for recycling wind turbine blades, according to a first embodiment;

FIG. 3 shows a container transporting softened blade sections;

FIG. 4 shows a system for recycling wind turbine blades, according to a further embodiment;

FIG. 5 shows a container at a softening and loading station;

FIG. 6 shows a first layer of blade sections loaded into the container;

FIG. 7 shows a second layer of blade sections loaded into the container;

FIG. 8 shows a pile of four layers of blade sections;

FIG. 9 shows the container in a closed state and the pile in a compressed state;

FIG. 10 shows the container of FIG. 9 being transported;

FIG. 11 shows a system for recycling wind turbine blades, according to a further embodiment;

FIG. 12 shows shreds of composite material being loaded into a container;

FIG. 13 shows a large uncompressed pile of shreds in the container;

FIG. 14 shows the pile in a compressed state;

FIG. 15 shows the container over-filled with shreds;

FIG. 16 shows the shreds compressed inside the container in a closed state;

FIG. 17 shows the container of FIG. 16 being transported;

FIG. 18 shows an alternative container with a cooling/fire suppression system;

FIG. 19 shows a system for recycling wind turbine blades, according to a further embodiment;

FIG. 20 shows a station with a conveyor chute which immerses shreds of composite material in liquid softening agent; and

FIG. 21 shows a station which sprays a stream of falling shreds with liquid softening agent.

### DETAILED DESCRIPTION OF EMBODIMENT(S)

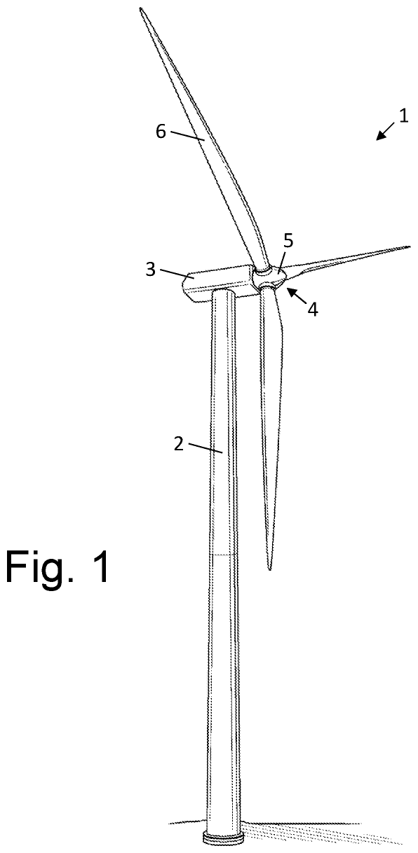

FIG. 1 shows a wind turbine 1. The wind turbine 1 has a tower 2 and a nacelle 3 at the top of the tower 2. A wind turbine rotor 4 is connected to the nacelle 3 and arranged to rotate relative to the nacelle 3. The wind turbine rotor 4 comprises a hub 5 and multiple blades 6 extending from the hub 5.

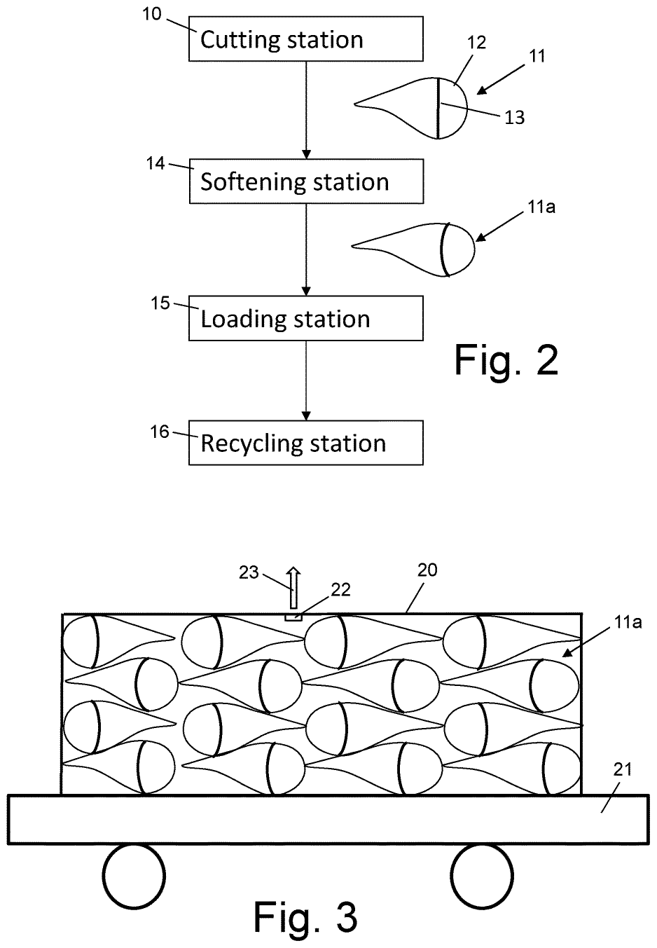

FIGS. 2 and 3 illustrate a method of recycling composite material from the blades 6, according to a first embodiment of the present invention.

First each blade 6 is divided into pieces of composite material. Each piece of composite material may also comprise non-composite materials, such as metal, polymer parts or coatings. In this example, the blade 6 is divided at a cutting station 10 by cutting it into sections in a chordwise direction. A cross-sectional view of one of the sections 11 is shown in FIG. 2. The section 11 comprises a shell 12 and a shear web 13.

The shell 12 and the shear web 12 are each principally made of composite material comprising reinforcement fibres embedded in a matrix material.

Most of the reinforcement fibres comprise glass fibres, although a small proportion of the fibres may comprise carbon fibres.

The matrix material may comprise a polymer, such as a polyester or an epoxy resin. The matrix material preferably comprises an amine cured thermoset epoxy resin.

The matrix material may comprise a cured thermoset material, such as an epoxy resin.

By way of example, the matrix material may comprise a Recyclamine® based epoxy system described in https: /www.abg-am.com/portfolio/chemistry/recyclamine-technology/F008?tab=1(online at 16 October 2022) or as described in La Rosa, Angela & Blanco, Ignazio & Banatao, Diosdado & Pastine, Stefan & Björklund, Anna & Cicala, Gianluca. (2018). Innovative Chemical Process for Recycling Thermosets Cured with Recyclamines® by Converting Bio-Epoxy Composites in Reusable Thermoplastic—An LCA Study. Materials. 11. 353. 10.3390/ma11030353 (referred to below as La Rosa et al).

In some cases, the softening of the matrix material may involve chemical or physical degradation of the matrix material. It was found that softening the matrix advantageously involves swelling and fragmenting of the matrix material. In some cases, the softening of the matrix material may involve partial dissolving of the matrix material.

The matrix material of the sections 11 is softened by treating the sections 11 with a liquid softening agent at a softening station 14.

The chemical composition of the liquid softening agent will depend on the nature of the matrix material to be softened. For instance the liquid softening agent may comprise an organic solvent such as hexane or toluene; or an acid, preferably with pH below 4, most preferably with a pH below 3.

By way of example the liquid softening agent may comprise acetic acid or formic acid. These have relatively low environmental impact and have been found to be effective at softening certain thermoset matrix materials.

Organic or aqueous solvents, and a catalyst, may also be included as part of the liquid softening agent.

In one embodiment the liquid softening agent comprises 70% acetic acid or more acetic acid. In another embodiment, the liquid softening agent comprises at least 50% formic acid.

The liquid softening agent transforms the sections 11 into softened sections 11a. Each softened section 11a may change shape under the force of its own weight or by applying an external force (not shown), becoming generally more flattened. This flattening is assisted by bending of the softened shear web 13 and/or reduction of stiffness of the blade shell 12 as indicated in the softened section 11a. The change of shape may occur as the sections are softened, or after the sections have been softened.

Before the softening, at least some of the sections 11 may have an aspect ratio greater than 2, or greater than 3, or greater than 10. The aspect ratio is a ratio between a largest dimension and a smallest dimension of the section 11. The flattening may increase the aspect ratio.

The sections 11 may be relatively large, and at least some of the sections 11 may have at least one dimension greater than 100 cm, or greater than 200 cm.

The softening agent may be applied at the softening station 14 in a variety of different ways, such as by spraying or by immersing the sections 11 in a bath of the softening agent.

The liquid softening agent may be heated so that it is above an ambient temperature as it treats the sections 11.

The softening agent may be at a temperature greater than 50° C. or greater than 70° C. as it treats the sections 11. A higher temperature was found to increase the speed of softening.

The softening agent may be at a temperature less than 100° C. or less than 50° C. as it treats the sections 11. A lower temperature will reduce energy requirements and evaporation of the softening agent. A temperature of between 20° C. and 50° C. has been found to represent a suitable compromise, where softening is relatively fast and evaporation is limited.

Optionally the softening agent is at ambient temperature as it treats the sections 11.

After the sections 11 have been softened at the softening station 14, they are loaded into a container 20 as shown in FIG. 3. The flattened shape of the softened sections 11a enables them to be packed into the container 20 with a higher packing density than would be possible in their unsoftened state.

Optionally the liquid softening agent 51 softens the matrix material by being absorbed into the matrix material. This may cause the matrix material to swell, causing a local increase in wall thickness of the shell 12 and the shear web 13. Such local swelling is counteracted by the global change of shape of the softened sections 11a which enables them to be packed together more tightly despite the increased local wall thickness. Hence, it was surprisingly possible to achieve packing of more composite material in a confined space (such as a container) even though extra material in the form of softening agent was added.

The softened sections 11a may form a pile of softened pieces in the container 20, with the softened sections 11a stacked one on top of each other.

The softening of the pieces 11 is initiated at the softening station 14 before the pieces are loaded into the container at the loading station 15, but the sections may remain soaked by the softening agent so that the softening process continues at the loading station 15, after the sections have been loaded into the container.

At least some of the softened sections 11 may change shape when they are within the pile, for example due to further softening or due to the weight of the softened sections above them in the pile. This change of shape may further increase a packing density of the pile. Furthermore, external force may also be applied to facilitate further increase in packing density of the pile.

The container 20 is then loaded onto a vehicle 21, such as a truck, train or ship. The vehicle 21 transports the container to a recycling station 16 where the softened sections 11a may be removed from the container 20 and the reinforcement fibres recycled by separating them from the matrix material, for instance by treating the softened sections 11a with a separation agent, such as a liquid separation agent.

Optionally, the container may be stored after arrival to the recycling station. This may be advantageous if the degradation of the composite material has not reached the level required upon arrival. For example if the temperature is relatively low, it may be most efficient to continue the process in the container for a while prior to continuing the recycling process in the recycling station. The storage may be continued until a predetermined level of degradation of the composite material is realized, which for example may correspond to a predetermined time/temperature exposure, a certain predetermined composition of the liquid softening agent, a certain amount of composite material being separated from the liquid softening agent.

Most typically the separation agent is an acid, preferably with pH below 4, most preferably with a pH below 3. By way of example the acid may be acetic acid or formic acid. Organic or aqueous solvents, and a catalyst, may also be included.

The separation agent may have the same chemical composition as the liquid softening agent. The separation agent may comprise the same active compounds as the liquid softening agent with different concentrations and/or ratio.

### Optionally, the Separation Agent Is a Solution of Dilute (20-80%) Formic Acid.

Optionally the separation agent is a recycling solution of acetic acid which is applied as described in La Rosa et al, by placing the sections in a dilute (25%) acetic acid recycling bath of 70° C. for 1 h. Once the thermoset matrix is fully dissolved or degraded to a degree where the reinforcement fibres are released, the reinforcement fibres can be removed from the recycling solution, rinsed for example in water, and dried at room temperature. To reclaim the epoxy, the acidic recycling liquid may for example be neutralized with sodium hydroxide base (NaOH) under suitable conditions for example to facilitate depolymerisation of the epoxy.

By transporting the composite material in relatively large pieces, relatively long reinforcement fibres can be recovered at the recycling station 16, for example with a length greater than 10 cm, or greater than 20 cm or greater than 50 cm or greater than 100 cm. This is particularly useful for carbon fibre which has high value as a recycled product.

The liquid softening agent may be removed from the softened sections 11a before they are loaded into the container 20, but more preferably at least some of the softening liquid remains in contact with the softened sections 11a, thereby degrading the matrix material in the container 20 during the transporting of the container 20. This degradation may be advantageous since it initiates the chemical treatment process earlier, thereby saving time and/or space at the recycling station 16. Further, it may reduce or even remove the requirement of providing heating during the degradation of the matrix as time is less restricted.

The container 20 is closed after loading the sections 11a into the container and remains closed during the transporting of the container.

Fumes may be generated by the degradation process, and the container 20 may have a pressure release valve 22 which enables such fumes 23 to escape.

The pressure in the container 20 may be increased by the degradation process, and the pressure release valve 22 may ensure that the pressure in the container does not go too high.

The softening process may be initiated at the softening station 14, or it may be initiated at the cutting station 10 by spraying liquid softening agent onto the sections 11 as part of dust retention, and/or by using the liquid softening agent as a jet to cut the blade. The liquid softening agent may enhance the cutting process.

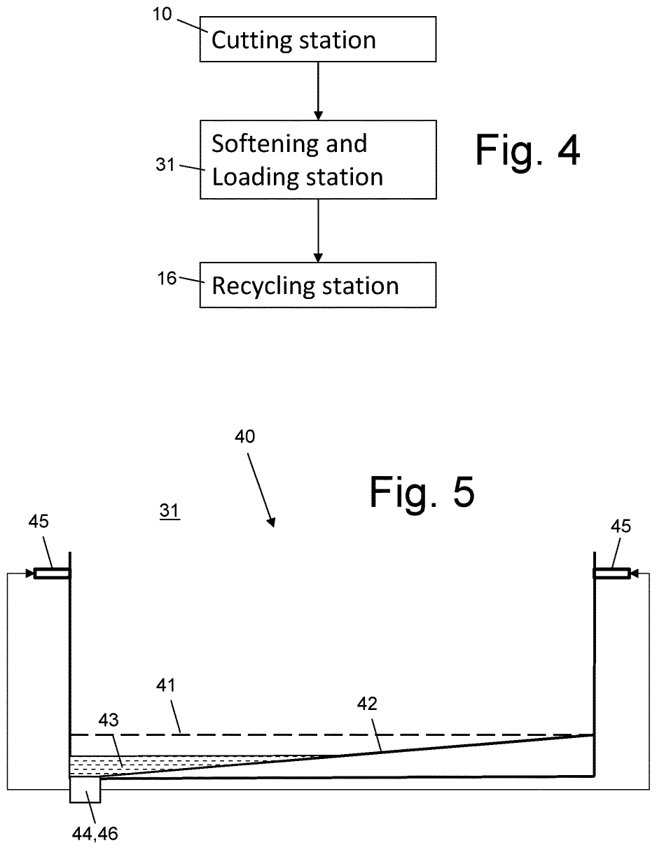

FIGS. 4-10 illustrate a method of recycling composite material according to a second embodiment of the present invention. Certain elements of FIGS. 4-10 are also shown in FIGS. 2 and 3. These elements are given the same reference number and will not be described again.

In FIG. 2 the sections 11 are softened at a softening station 14, then the softened sections 11a are loaded at a loading station 15. In FIG. 4, the sections are both softened at loaded at a softening and loading station 31 as shown in FIGS. 5-9.

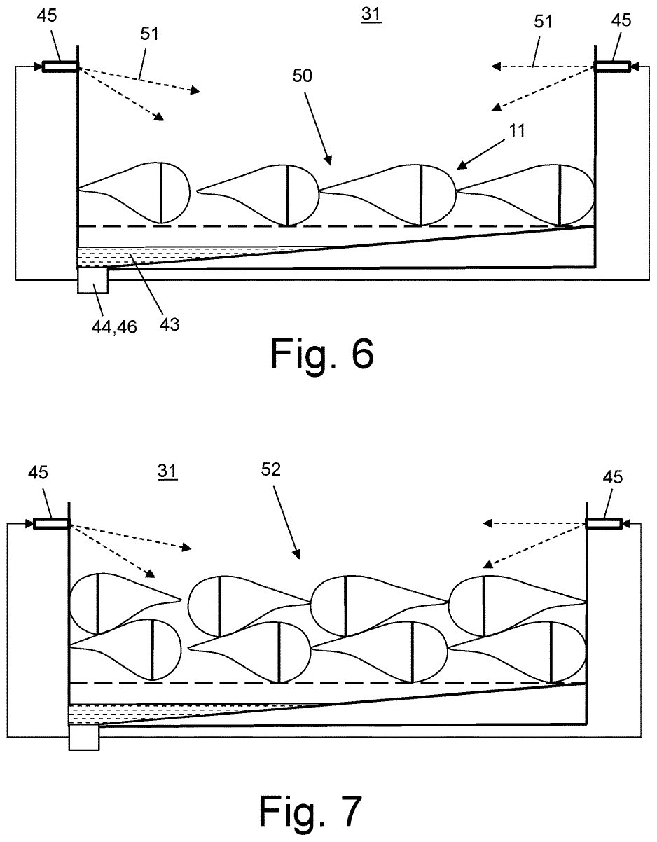

A container 40 for transporting composite material is provided at the station 31. Unlike the more conventional container 20 of FIG. 3, the container 40 comprises a system configured to apply a liquid softening agent onto the composite material-in this case nozzles 45 configured to spray liquid softening agent 51 onto the composite material as shown in FIG. 6.

The chemical composition of the liquid softening agent 51 may be as described in the previous embodiment, so will not be described again.

The container 40 has a liquid-tight floor 42 which inhibits leakage of the liquid, and a grid 41 which acts as a false floor. The space under the grid 41 provides a sump which stores a stock 43 of the liquid softening agent 51.

Optionally the liquid softening agent 51 may be heated so that it is above an ambient temperature outside the container 40 as it treats the sections. Suitable temperatures are given in the previous embodiment and will not be described again. By way of example the liquid softening agent 51 may be heated by a heating element in the sump.

A circulation system is configured to capture liquid which has contacted the composite material and feed it back onto the composite material. The circulation system comprises a pump 44 configured to feed the liquid from the stock 43 to the nozzles 45. Piping for the circulation system may be arranged in the container walls, container floor and/or container ceiling.

It was found to be highly advantageous that the circulation system comprises a liquid softening agent refining station, 46, which may be integrated with the pump, the circulation system or a separate component of the container. The softening agent may degrade the composite material and particularly the matrix material physically and/or chemically so the liquid softening agent over time may contain growing amounts of dissolved (for example via chemical disassembling of the resin) or particulate (for example via swelling disintegration) solid matrix material, reinforcement fibres or other constituents of the composite material released during the transportation. A liquid softening agent refining station may separate such composite material elements transported in the liquid softening agent from the liquid softening agent for example by filtering, settling chambers, cooling traps, a combination of these or other known liquid refining techniques. This allows the liquid softening agent to retain the active process during the transport and reduce the wear and risk of plugging of the circulation system and hence improve efficiency of the recycling method and the container.

The refining station is preferably arranged in the container wall or the container floor. The refining station may be equipped with a storage chamber for material separated from the liquid softening agent, from which storage chamber it may easily be retracted after the container has reached the recycling station.

Unsoftened sections 11 may be loaded layer-by-layer into the container as shown in FIGS. 6-8. As the sections 11 are loaded, the system is configured to spray the liquid softening agent 51 onto the sections 11 from above.

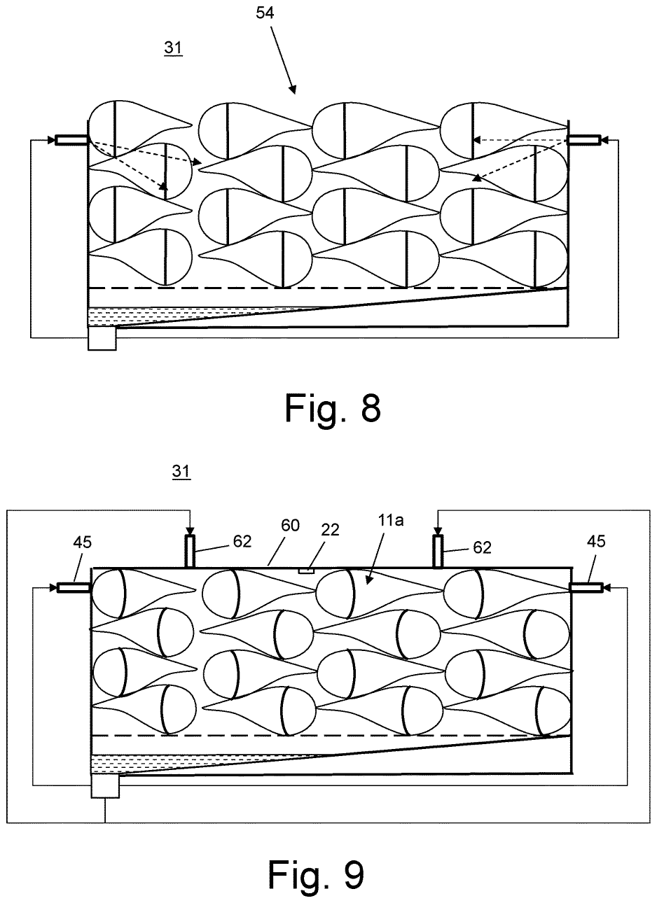

FIG. 6 shows a first layer 50 of the sections 11, FIG. 7 shows a pile 52 formed from two layers, and FIG. 8 shows a pile 54 formed from four layers.

The pile 54 illustrated in FIG. 8 is relatively ordered, but this is schematic only and more typically the pile 54 will be less ordered since the blade sections will be a variety of different shapes and sizes.

As in the previous embodiment, the liquid softening agent 51 transforms the sections 11 into softened sections 11a. Each section may change shape after it has been softened under the force of its own weight and/or from the weight of the sections above it in the pile, becoming generally more flattened as shown in FIG. 9.

After the sections have been loaded as shown in FIG. 8, a cover 60 is fitted as shown in FIG. 9 to close the container. The cover 60 may compress the pile of softened pieces in the container by applying a downward compression force to the pile, thereby increasing the global packing density of the pile and enabling the container to be closed.

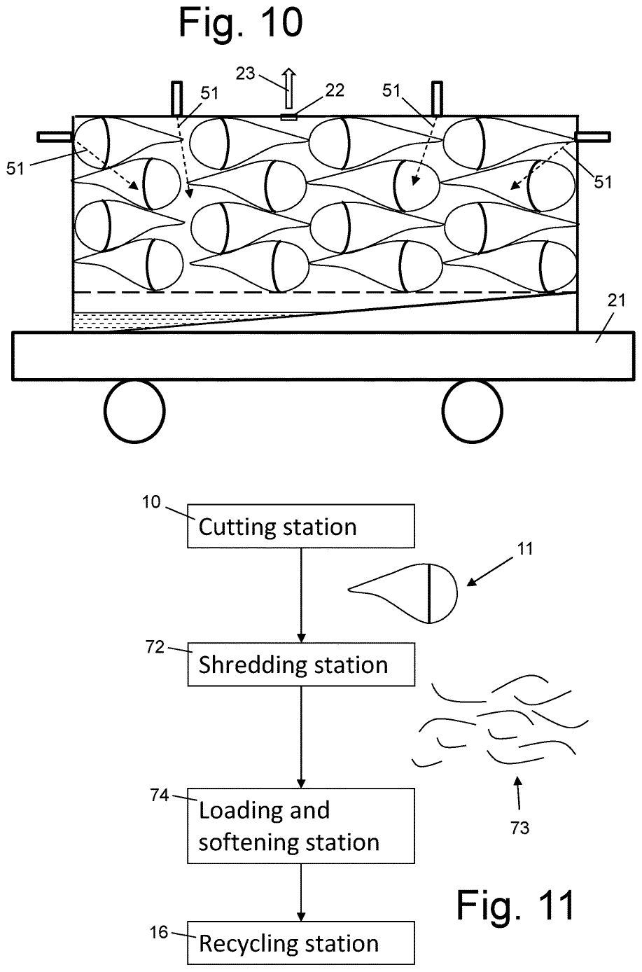

Optionally the cover 60 has further nozzles 62 which can spray liquid softening agent 51 onto the sections from above as in FIG. 10.

The container 40 is then loaded onto a vehicle 21 as in the previous embodiment, then transported to the recycling station 16. The recycling process has been described above and will not be described again.

The liquid softening agent 51 may be applied to the composite material in the container during the transporting of the container. In this example, during the transporting of the container liquid softening agent 51 continues to be sprayed as shown in FIG. 10, trickles down through the pile into the sump, and is continuously recycled by the pump 44 (which is not shown in FIG. 10 for ease of illustration).

Compared with the embodiment of FIG. 2 (where the container has no system to apply liquid softening agent onto the composite material) the continuous spraying process of FIG. 10 provides more degradation of the matrix material in the container during the transporting of the container.

The liquid softening agent 51 may be heated, for instance by an electrical heating element in the sump or any other suitable method. Heat may be applied to speed up the degradation/swelling process to reach a predetermined level before the container 40 reaches the recycling station 16. In some cases, heating is not required due to extended transportation time and energy may hence be saved. In other cases, heating is used to prevent solidification of the softening agent due to low ambient temperature during transportation.

Other process parameters may also be changed during transport (i.e. increased and/or decreased) such as the acidity of the liquid softening agent, the circulation rate, or the volume of liquid softening agent in the sump.

In an alternative embodiment the softened sections 11a may be fully immersed in liquid softening agent during transport, but this would significantly add to the weight of the container. The circulation system ensures that the sections remain soaked in the liquid softening agent 51 during transport without requiring them to be fully immersed.

The stock 43 of liquid softening agent 51 may be drained from the sump at the recycling station 16, or it may be re-used for the next load of composite material.

FIGS. 11-17 illustrate a method of recycling composite material according to a further embodiment of the present invention. Certain elements of FIGS. 11-17 are also shown in FIGS. 2-10, and these elements are given the same reference number and not described again.

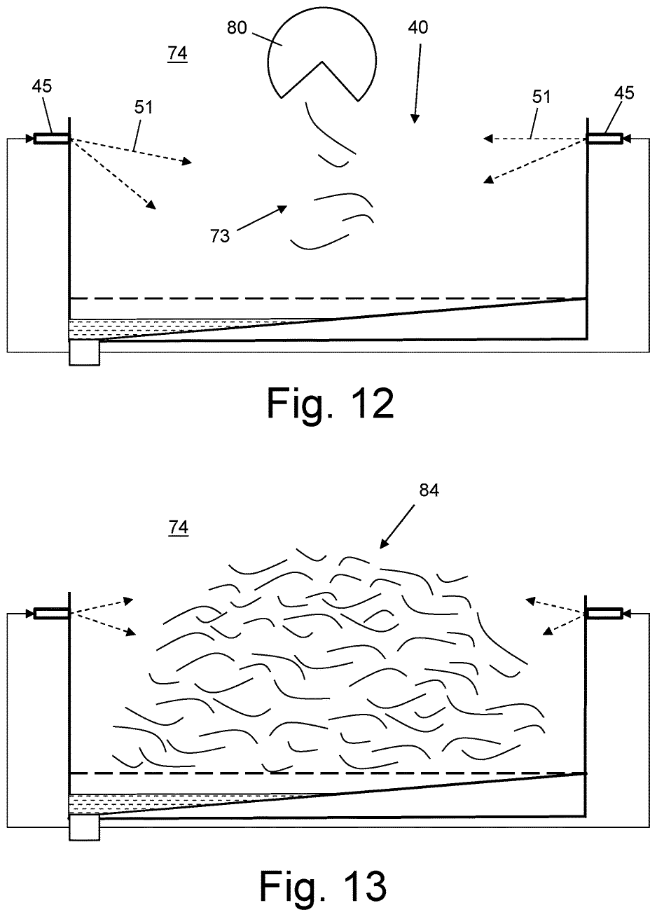

In FIGS. 2-10 the wind turbine blade is divided by cutting it into blade sections, and the relatively large sections constitute the pieces which are loaded into the container and transported to the recycling station 16. In the embodiment of FIGS. 11-17, the blade sections are further divided by being shredded at a shredding station 72 to provide shreds 73 which are loaded into the container 40 at a loading and softening station 74 as shown in FIGS. 12-16.

Before the softening, at least some of the shreds 73 may have an aspect ratio greater than 5, or greater than 10. The aspect ratio is a ratio between a largest dimension and a smallest dimension of the shred 73.

The shreds 73 are much smaller than the blade sections 11, but at least some of the shreds 73 may have at least one dimension greater than 10 cm, or greater than 20 cm.

At least some of the shreds 73 may have reinforcement fibres with a length greater than 10 cm, or greater than 20 cm.

The shreds 73 are loaded into the container in batches at the loading and softening station 74 from an excavator bucket 80 as shown in FIG. 12. Liquid softening agent 51 is sprayed from the nozzles 45 onto the shreds 73 during the loading process.

A large dis-ordered pile 84 of shreds builds up as shown in FIG. 13. At least some of the softened shreds may change shape when they are within the pile 84, for example due to softening or due to the weight of the softened shreds above them in the pile. This change of shape may increase a packing density of the pile 84 by allowing the shreds in the pile to settle more easily. The change of shape may comprise flattening and/or bending and/or twisting for example.

Optionally the excavator bucket 80 or another member for applying force may compress the pile 84 of softened shreds in the container by applying a downward compression force to the pile 84, thereby increasing the global packing density of the pile and enabling the container to be closed.

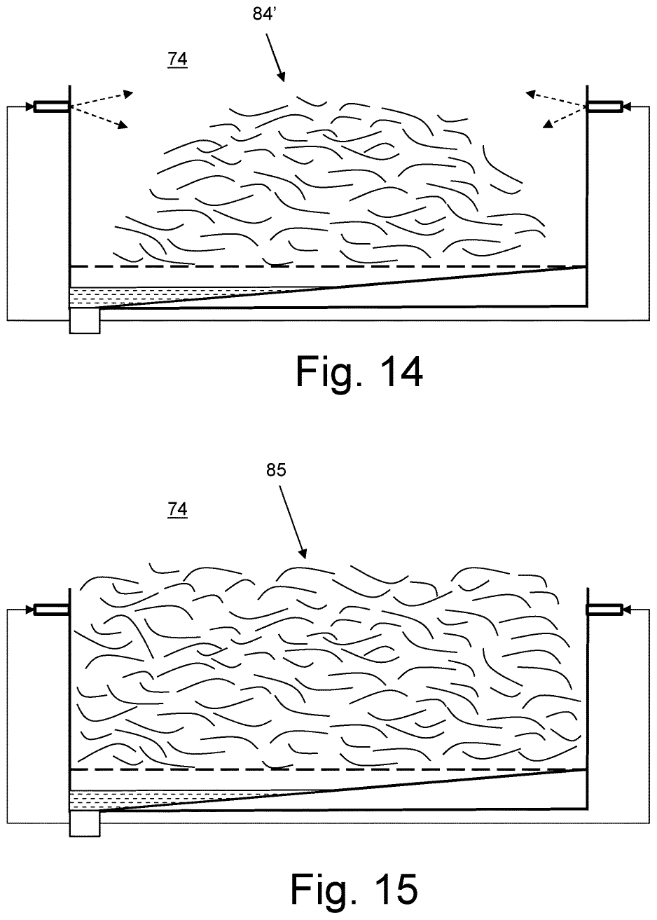

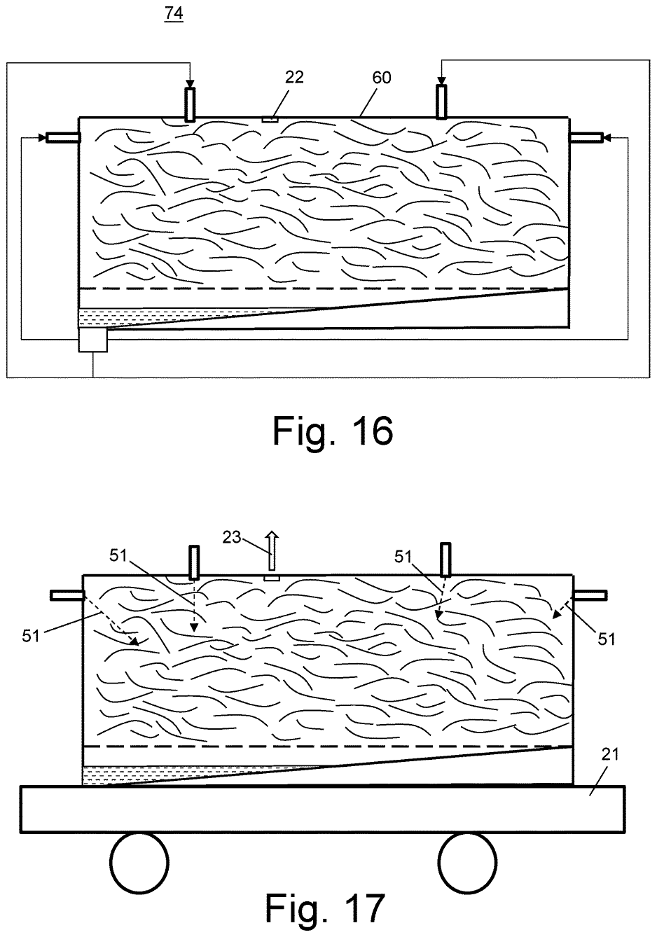

FIG. 14 shows the pile 84 in a compressed state (indicated as a compressed pile 84′). The compressed pile 84′takes up less space so further shreds can be added as in FIG. 15 to form a larger pile 85 which may be at the weight limit of the container. The pile 85 is then further compressed by the cover 60 during closing of the container as shown in FIG. 16.

The liquid softening agent 51 may continue to be sprayed from the nozzles during the loading process of FIGS. 12-16, and during the transportation process of FIG. 17. Similarly, the refining station for the liquid softening system may continue to be operated during the transportation process.

As in the previous embodiment, the circulation process ensures that the shreds remain soaked in the liquid softening agent 51 during transport.

The softening process may be initiated at the loading and softening station 74, or it may be initiated earlier. For instance the softening process may be initiated at the cutting station 10 by spraying liquid softening agent onto the sections 11 as part of dust retention, and/or using the liquid softening agent as a jet to cut the blade. The softening process may also be initiated or continued at the shredding station 72 by spraying liquid softening agent onto the sections 11 as part of dust retention.

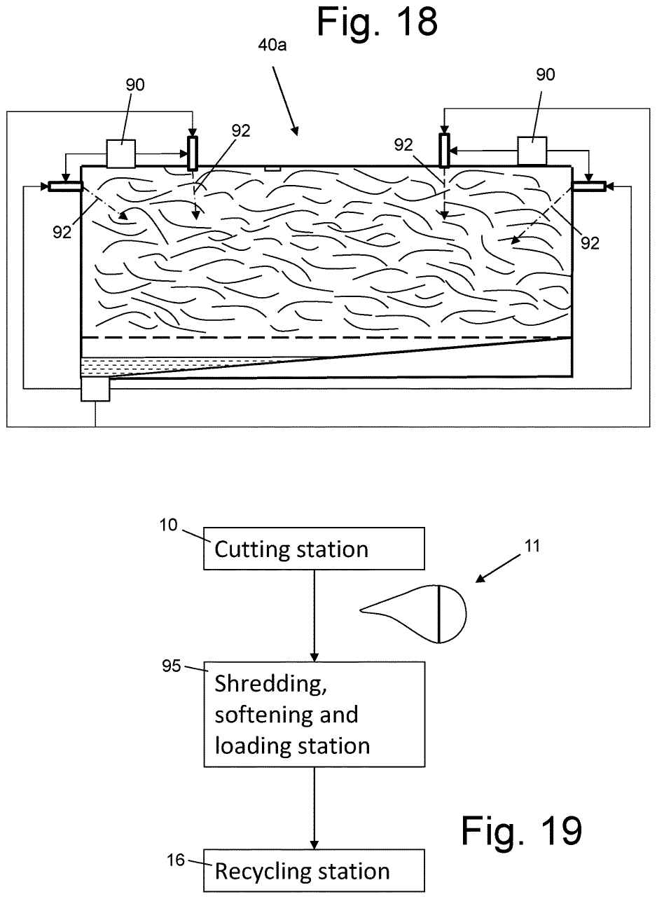

FIG. 18 shows an alternative container 40a. The container 40a is similar to the container 40, so only the differences will be described. The container 40a comprises a cooling/fire suppression system where a cooling fluid 92 (for instance carbon dioxide, liquid nitrogen or water) is supplied into the circulation system upon activation by a sensor or manual switch (not shown). In this case the cooling fluid 92 is supplied from tanks 90 connected to the nozzles.

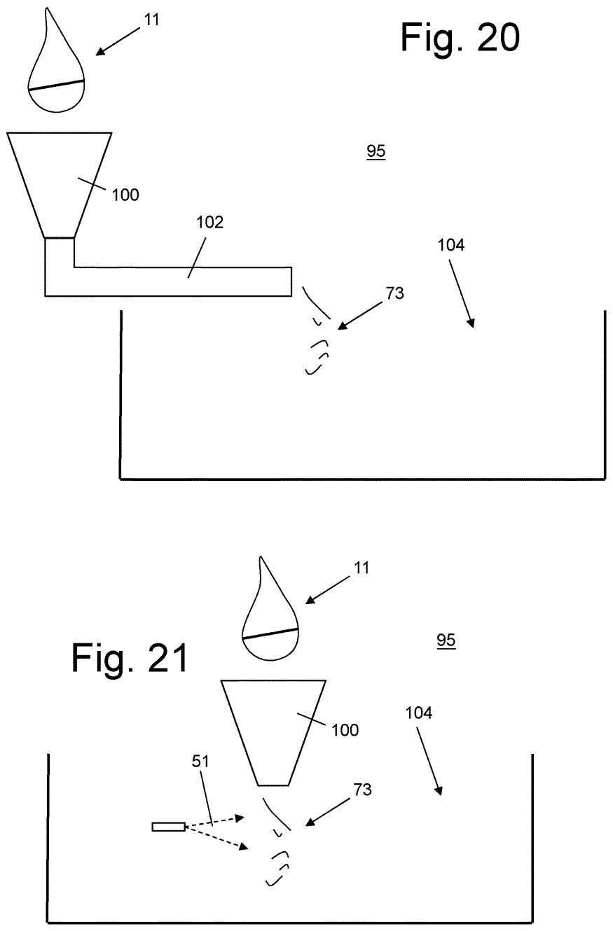

In FIGS. 11-17, the blade sections are shredded at a shredding station 72 to provide shreds 73 which are loaded into the container 40 at a loading and softening station 74. FIGS. 19-21 show a further embodiment in which the blade sections are shredded, softened and loaded at a shredding, softening and loading section 95 as shown in FIGS. 20 and 21.

FIG. 20 shows a first embodiment of the shredding, softening and loading section 95. The sections are loaded into a shredder 100 which shreds the sections 11 and feeds the shreds 73 into a conveyor chute 102. The conveyor chute 102 contains a feed screw (not shown) immersed in liquid softening agent. As the shreds are fed along the conveyor chute 102 by the feed screw, they become soaked in the liquid softening agent before they fall into the container 104. Thus the shreds 73 are treated with the liquid softening agent as they are loaded into the container 104.

FIG. 21 shows a second embodiment of the shredding, softening and loading section 95. A stream of shreds 73 falls under gravity from the shredder 100, and liquid softening agent 51 is sprayed onto the stream of shreds 73 from a nozzle which may or may not be part of the container 104. Thus the shreds 73 are treated with the liquid softening agent 51 as they are loaded into the container 104.

Heat may be generated by the degradation process, causing the temperature in the container to increase during transport. This may enhance the speed of the degradation process, so the container 20, 40, 40a, 104 in any of the above embodiments may be insulated to reduce heat loss-for instance by being lined with an insulating material or being doubled-walled.

In the embodiments above, the pieces of composite material are treated and transported in the form of sections 11a or shreds 73, but in other embodiments the pieces of composite material may have other forms such as beads, granules, flakes, chips or slices.

In the embodiments above, the liquid softening agent 51, and/or the liquid separation agent applied at the recycling station 16, chemically treats the matrix material. By way of non-limiting example the liquid may comprise alcohol or water in a critical condition; an acid such as acetic acid or formic acid; or an organic solvent.

Optionally the liquid softening agent 51, and/or the liquid separation agent applied at the recycling station 16 comprises a solution of an active ingredient in water-for instance a solution of acetic or formic acid in water.

Optionally the liquid softening agent 51, and/or the liquid separation agent applied at the recycling station 16 at least partially chemically disassembles the matrix material, for instance by dissolving and/or depolymerising the matrix material and/or by solvolysis of the matrix material.

The embodiments above describe various methods of transporting and recycling composite material from wind turbine blades 6, but the present invention can be applied to transporting and/or recycling composite material from other sources.

Although the invention has been described above with reference to one or more preferred embodiments, it will be appreciated that various changes or modifications may be made without departing from the scope of the invention as defined in the appended claims.

1. A method of recycling composite material, the composite material comprising reinforcement fibres embedded in a matrix material, the method comprising: loading the composite material into a container; treating the composite material in the container with a liquid; transporting the container to a recycling station, wherein the liquid degrades the matrix material in the container during the transporting of the container; and at the recycling station, recycling the reinforcement fibres by separating them from the matrix material.

2. The method according to claim 1, wherein the liquid is applied to the composite material in the container.

3. The method according to claim 2, wherein the liquid is applied to the composite material in the container during the transporting of the container.

4. The method according to claim 1, wherein the liquid is sprayed onto the composite material, preferably by spraying the liquid from one or more nozzles within the container.

5. The method according to claim 1, wherein the container is closed after loading the composite material into the container, and the container remains closed during the transporting of the container.

6. The method according to claim 1, wherein the reinforcement fibres are separated from the matrix material at the recycling station by treating the composite material with a separation agent.

7. The method according to claim 1, wherein the composite material is composite material of a wind turbine blade.

8. The method according to claim 1, wherein the container is transported by a vehicle, such as a truck, train or ship.

9. The method according to claim 1, further comprising storing the container with composite material and liquid after arrival at the recycling station, preferably the container is stored until a predetermined level of degradation of the composite material is realized.

10. The method according to claim 1, wherein the liquid and/or the separation agent comprises an acid, preferably with pH below 4, most preferably with a pH below 3.

11. The method according to claim 10, wherein the acid is acetic acid or formic acid.

12. A container for transporting composite material, the container comprising a system configured to apply a liquid onto the composite material, wherein the system comprises a circulation system configured to capture liquid which has contacted the composite material and feed it back onto the composite material.

13. The container according to claim 12, wherein the system further comprises a liquid refining station for separating dissolved and/or particulate composite material from the liquid.

14. The container according to claim 12, further comprising a stock of liquid, preferably in a sump of the container, wherein the system is configured to apply liquid from the stock of liquid onto the composite material.

15. The container according to claim 14, wherein the liquid from the stock of liquid comprises an acid.

16. The container according to claim 15, wherein the acid is acetic acid or formic acid.
